(19) United States
(12) Patent Application Publication
(10) Pub. No.: US 2026/0003597 A1
(43) Pub. Date: Jan. 1, 2026

(54) APPLICATION PROGRAM MANAGEMENT BASED ON CLUSTERS

(71) Applicant: Dell Products L.P., Round Rock, TX (US)

(72) Inventors: Shibi Panikkar, Bangalore (IN); Subhashini Puram, Hyderabad (IN); Aashna Mohapatra, Bhubaneswar (IN); Ambarish Roy, Guwahati (IN)

(21) Appl. No.: 18/757,019

(22) Filed: Jun. 27, 2024

(51) Int. Cl. G06F 8/65

(52) U.S. Cl. CPC G06F 8/65

(57) ABSTRACT

Methods, apparatus, and processor-readable storage media for application program management are provided herein. An example computer-implemented method includes identifying at least one cluster of applications from among a plurality of applications based at least in part on structural information associated with the plurality of applications, determining that at least one application in the at least one cluster is using a first version of an application build tool, and updating the application build tool to a second version of the application build tool for the at least one application in the at least one cluster. The method also includes staging the at least one application using the second version of the application build tool.

### BACKGROUND

Applications hosted on cloud computing platforms benefit from high availability and resilience, which can be achieved by deploying them across multiple servers and geographic locations with built-in failover and disaster recovery mechanisms. Real-time monitoring, logging, and alerting systems also help to ensure effective management of such applications.

### SUMMARY

Illustrative embodiments of the disclosure provide techniques for application program management using clustering and feedback. An exemplary computer-implemented method includes identifying at least one cluster of applications from among a plurality of applications based at least in part on structural information associated with the plurality of applications and determining that at least one application in the at least one cluster is using a first version of an application build tool. The method also includes updating the application build tool to a second version of the application build tool for the at least one application in the at least one cluster, and restaging the at least one application using the second version of the application build tool.

Illustrative embodiments can provide significant advantages relative to conventional techniques. For example, technical problems associated with managing multiple applications, potentially maintained by different sets of users and/or organizations, are mitigated in one or more embodiments by automatically updating versions of application build tools for one or more clusters of applications to ensure that the applications maintain compliance with application build tool standards.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system with application management functionalities according to an illustrative embodiment.

FIG. 2 illustrates an information processing system with further details of an application management architecture according to an illustrative embodiment.

FIGS. 3-5 illustrate an example of application topology cluster classification according to an illustrative embodiment.

FIG. 6 illustrates an example of application build tool information according to an illustrative embodiment.

FIG. 7 illustrates an example of application management metadata according to an illustrative embodiment.

FIG. 8 illustrates a user interface and notification process according to an illustrative embodiment.

FIG. 9 shows a flow diagram of a process for application program management using clustering and feedback in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

Application management is important for an organization (e.g., enterprise, one or more individuals, etc.). Organizations should ensure that their applications are monitored for performance, availability, security, and compliance using automated tools and processes in place for management and maintenance. Furthermore, to reduce the risk of noncompliance and ensure that their applications are secure and protected, organizations should be proactive in recognizing and addressing these compliance issues. It is recognized that addressing these challenges often required a proactive and well-planned approach to maintenance, with effective monitoring and management tools, cost optimization strategies, and services in place.

Still further, finding the appropriate metadata for all applications to ensure compliance presents a significant challenge for any developer, including, but not limited to: (i) ensuring that application configuration details specified in a manifest file, such as memory limits, routes, and services, comply with private cloud platform (PCP) standards; and (ii) determining the topology, configurations, and environments. A typically large organization may have thousands of applications and handling each one of them takes time and computing resources. As an application matures and the PCP changes, developers should ensure that their applications meet compliance with PCP standards. One non-limiting example of a PCP is Pivotal Cloud Foundry (PCF), which is a multi-cloud, open-source service from VMware that allows development teams to run applications on various on-demand cloud computing platforms (e.g., Infrastructure-as-a-Service (IaaS) or Platform-as-a-Service (PaaS)), including, but not limited to, Amazon Web Services (AWS), Google Cloud Platform (GCP), and Microsoft Azure.

Application management pipelines often utilize application build tools that transform application source code into runnable artifacts by analyzing the source code to determine an appropriate way to build the application. In some examples, an application build tool can be referred to as a “buildpack.” In the context of a cloud environment, buildpacks transform application source code into images that can run on any cloud. Images may be read-only templates that contain instructions for creating a container. A container image is thus, for example, a snapshot or blueprint of libraries and dependencies required inside a container for an application to run. Buildpacks allow application developers to focus on writing code without having to deal with issues such as, but not limited to, container image security, container image optimization, or container build strategy. However, even with buildpacks, existing approaches still may require that developers or other users follow release notes, confluence pages, and GitHub links of various technologies, as well as manually modify and update the manifest file and redeploy the applications. These manual approaches, among other technical drawbacks, have a significant risk of missing updates from multiple sources.

Illustrative embodiments further reduce the need for manual intervention in the above and other scenarios by introducing the concept of an automatic buildpack compliance management system and associated methods. In some embodiments, the associated methods monitor various sources for changes and notify the user (e.g., application developer) when it is time to deploy and (re) stage the applications for cloud computing, which can then invoke an automatic (re) staging process. Illustrative embodiments also provide a feedback loop mechanism to identify a cluster of applications that are buildpack-compliant and thus safe to proceed.

It is recognized that the topology of an application on a cloud computing platform can vary greatly depending on the architecture, infrastructure, and requirements of the application. The topology of an application can include several components including, but not limited to a front-end component, a back-end component, a data storage layer, and an application layer, and each component has its own configuration.

The topology and configuration of a given application may be constantly changing, and failing to update the application may result in the cloud architecture upon which the application runs being deemed non-compliant. Now consider that an organization may have thousands of applications and application programming interfaces (APIs) to maintain on a regular basis.

Metadata is also an important aspect of cloud automation and management, as it enables cloud management platforms to automate the deployment and configuration of applications in the cloud environment. In an organization with thousands of applications to maintain, it can take significant time to collect the necessary metadata, resulting in complex settings and handlers.

The automation that exists to address these issues in cloud application maintenance requires the user to directly update the manifest file. After the changes are updated, the application should be redeployed and restaged.

Any changes required by the PCP are raised as a buildpack to different applications. Developers are notified of any buildpack updates, operating system changes, infrastructure updates, library updates, database updates, or application dependency update changes through a communication channel or platform notification via email or in-application notifications. When a new version is released, developers must ensure they subscribe to the release notes of all these dependencies across the many applications they utilize to stay aware of any changes.

In a large-sized organization, the number of applications deployed on cloud computing platforms utilizing various buildpacks for different technologies is significant. Modifications occurring across various parts of the organization under various technologies increase the complexity and work required to keep the applications secure and compliant.

Regardless of the specific cloud computing platform, it is important for developers to stay informed of buildpack and other updates and take appropriate action to apply them in a timely manner. This can help ensure that the application remains secure and protected against potential security threats. In many circumstances, missing updates are discovered after an application is down, and if the user is new, they may spend significant time identifying the cause of the failure, applying the updates, and eventually restaging the application.

By staying informed of buildpack updates, developers can take advantage of new features and security updates and ensure that applications are up-to-date and running optimally. There is thus a need for the creation of reusable and automated cloud deployment processes that can handle application management without affecting users.

At least some embodiments described herein provide such automated application management. For example, in some embodiments, a user interface is configured with a built-in background process, which enables a user to enter information identifying one or more local repository paths and groupings of related applications and services. In some embodiments, the groupings can be associated with one or more users and/or one or more user accounts. With this knowledge, the tool emits the appropriate applications in the private cloud platform from the local repository and feeds data into the local repository with details about the buildpack being used in conjunction with a specific technology. When a version mismatch is discovered, the data is compared to the most recent buildpack data for each technology, and the user is notified after updating the build packs in the local repository path. When the user agrees to restage the applications, buildpack updates automatically take place in the background (e.g., without user involvement), and the user is notified upon completion.

In the context of a PCP environment, the groupings of related applications and services can correspond to a cloud organization (also referred to as an “cloud org”). Generally, a cloud org refers to a development account that can be associated with an individual or multiple collaborators. This enables collaborators within a cloud org to share resources (e.g., applications, service availability, and custom domains), and also provides a level of isolation by separating applications, services, and user roles from other cloud organizations within the same cloud deployment.

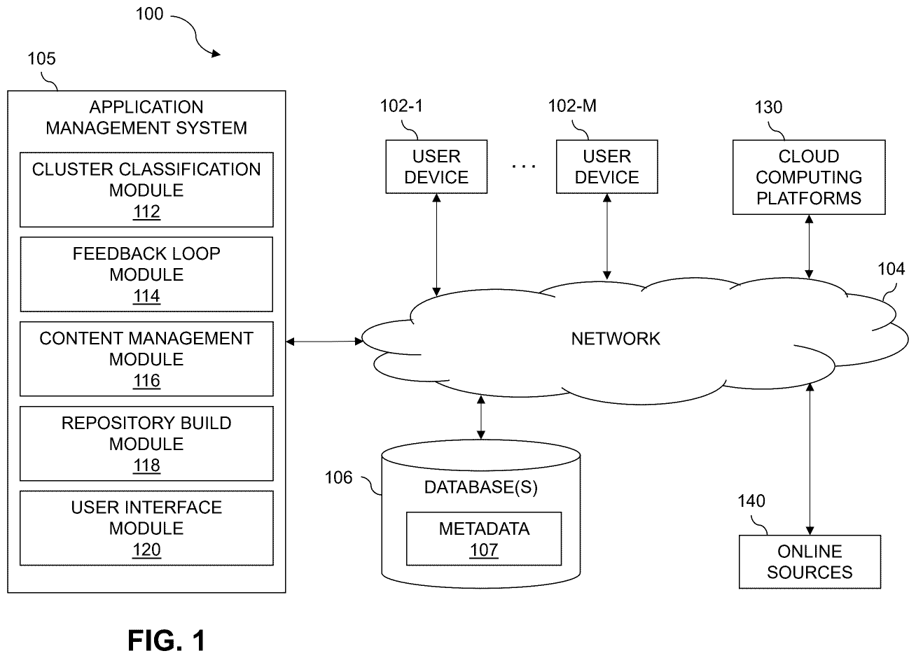

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an application management system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the application management system 105 can have at least one associated database 106 configured to store data pertaining to, for example, applications and/or build tools, such as buildpacks.

An example database 106, such as depicted in the present embodiment, can be implemented using one or more storage systems associated with the application management system 105. Such storage systems can comprise any of a variety of different types of storage including network-attached storage (NAS), storage area networks (SANs), direct-attached storage (DAS), and distributed DAS, as well as combinations of these and other storage types, including software-defined storage.

Also associated with the application management system 105 are one or more input-output devices, which illustratively comprise keyboards, displays, or other types of input-output devices in any combination. Such input-output devices can be used, for example, to support one or more user interfaces to the application management system 105, as well as to support communication between application management system 105 and other related systems and devices not explicitly shown. Also coupled to the network are one or more cloud computing platforms 130 and one or more online sources 140.

Additionally, the application management system 105 in the FIG. 1 embodiment is assumed to be implemented using at least one processing device. Each such processing device generally comprises at least one processor and an associated memory, and implements one or more functional modules for controlling certain features of the application management system 105.

More particularly, the application management system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the application management system 105 to communicate over the network 104 with the user devices 102, the one or more cloud computing platforms 130, and/or the one or more online sources 140, and illustratively comprises one or more conventional transceivers.

The application management system 105 further comprises a cluster classification module 112, a feedback loop module 114, a content management module 116, a repository build module 118, and a user interface module 120.

Generally, the cluster classification module 112 clusters applications (e.g., associated with user devices 102) into one or more clusters, where each cluster corresponds to a particular technology and/or version of such technology, as explained in more detail elsewhere herein. According to at least some embodiments, the cluster classification module 112 can utilize one or more machine learning clustering algorithms to assign applications to clusters. One non-limiting example of a clustering algorithm is a k-means clustering algorithm. Generally, a k-means clustering algorithm attempts to partition data (e.g., application and/or buildpack data) into a number, k, of clusters, where each data point belongs to the cluster with the nearest mean.

In some embodiments, the feedback loop module 114 updates information related to applications within the clusters that have successfully updated application build tools (such as buildpacks) to newer versions.

The content management module 116 maintains information related to the latest versions of the application build tools for a variety of technologies. In some embodiments, the content management module 116 periodically collects the information from the online sources 140. For example, the online sources 140 can correspond to websites hosted by one or more servers that post information related to different versions of the technologies (e.g., release note pages and/or forum posts), and the content management module 116 can collect and store such information in a centralized location (e.g., in the one or more databases 106).

The repository build module 118 generates a repository of metadata (e.g., metadata 107) based on information related to local repositories comprising applications and groupings of such applications. In some embodiments, the information can be provided by a user associated with one of the user devices 102 and can comprise paths of the local repositories and information identifying one or more cloud organizations associated with the applications.

The user interface module 120 can communicate with the content management module 116 to receive user input from one or more of the user devices 102 (e.g., local repository paths and/or information identifying cloud organizations). In some embodiments, the user interface module 120 enables users to monitor and manage applications and/or buildpacks. The user interface module 120 can generate notifications to alert users when a new version of a buildpack becomes available, for example. The user interface module 120 can also be configured to receive input from a user for approving the restaging applications using new buildpack versions and/or approving deployment of the applications (e.g., to at least one of the cloud computing platforms 130).

It is to be appreciated that this particular arrangement of elements 112, 114, 116, 118, and 120 illustrated in the application management system 105 of the FIG. 1 embodiment is presented by way of example only, and alternative arrangements can be used in other embodiments. For example, the functionality associated with the elements 112, 114, 116, 118, and 120 in other embodiments can be combined into a single module or separated across a larger number of modules. As another example, multiple distinct processors can be used to implement different ones of the elements 112, 114, 116, 118, and 120 or portions thereof.

At least portions of elements 112, 114, 116, 118, and 120 may be implemented at least in part in the form of software that is stored in memory and executed by a processor.

It is to be understood that the particular set of elements shown in FIG. 1 for application management system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the application management system 105 and the databases 106 can be on and/or part of the same processing platform. As another example, at least some of the elements 112, 114, 116, 118, and 120 can be implemented, at least in part, on one or more of the user devices 102 and/or one or more of the cloud computing platforms 130.

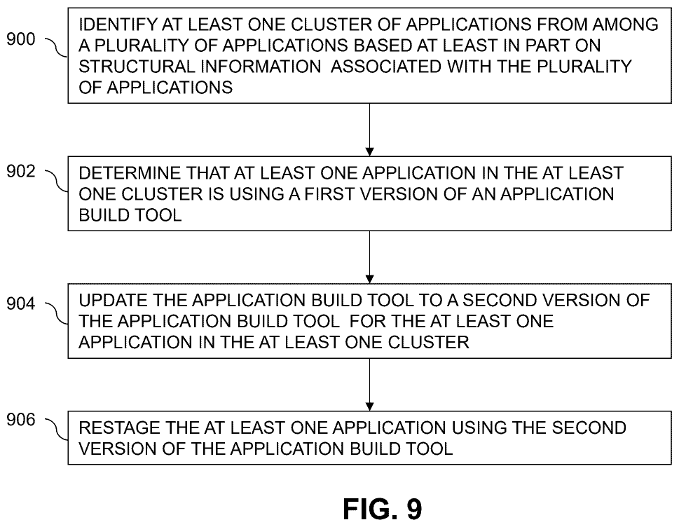

An exemplary process utilizing elements 112, 114, 116, 118, and 120 of an example application management system 105 in computer network 100 will be described in more detail with reference to, for example, the flow diagram of FIG. 9.

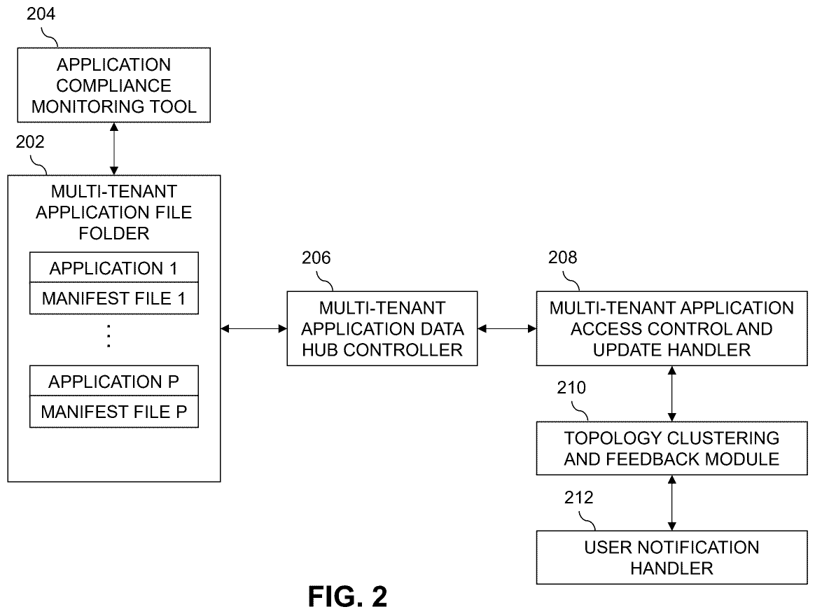

FIG. 2 illustrates an information processing system with further details of an application management architecture according to an illustrative embodiment. The architecture shown in FIG. 2 includes a multi-tenant application file folder 202 that stores information for a plurality of applications 1, . . . P and a corresponding plurality of manifest files 1, . . . P. It is to be appreciated that the manifest files can be used for deploying the corresponding application. In at least one embodiment, a manifest file can include an identifier of the corresponding application (e.g., an application name), dependencies needed to run the application, buildpack information, one or more environment variables, memory allocation information, scaling parameters, and/or other parameters related to deploying the application. Additionally, the manifest file can be version controlled to enable rollback and auditing of the application.

The architecture in FIG. 2 also includes an application compliance monitoring tool 204, a multi-tenant application data hub controller 206, a multi-tenant application access control and update handler 208, a topology clustering and feedback module 210, and a user notification handler 212.

In some embodiments, the application compliance monitoring tool 204 can be implemented using the user interface module 120, and the application compliance monitoring tool 204 can be automatically started in response to a user logging into the system (e.g., the application management system 105). The application compliance monitoring tool 204 can monitor the multi-tenant application file folder 202.

The multi-tenant application data hub controller 206 can coordinate and manage data related to the multi-tenant application file folder 202. For example, the multi-tenant application data hub controller 206 can manage access to the multi-tenant application file folder 202 by multiple applications and/or users, as well as manage the storage, retrieval, and organization of the data within the multi-tenant application file folder 202. As a non-limiting example, the multi-tenant application data hub controller 206 can make updates to one of the manifest files in response to an application being restaged.

The multi-tenant access control and update handler 208 can include functionality for authenticating and/or authorizing one or more users to access specific applications and/or buildpacks. The multi-tenant access control and update handler 208 can also process update requests, check for newer buildpack versions associated with the applications, and initiate application restaging and deployment.

The topology clustering and feedback module 210 categorizes the applications based on the application structure (or topology) and the versions of technology (e.g., software and/or services) used in the applications. In some embodiments, the topology clustering and feedback module 210 assigns a given application to one or more clusters. In some embodiments, the topology clustering and feedback module 210 can apply one or more clustering criteria to assign the application to the clusters. For example, the clustering criteria can be based on the software and/or services used by the applications. The clustering criteria can alternatively or additionally be based on any cloud organizations associated with such applications.

In some embodiments, a new version of a buildpack can be applied to restage one of the applications. If the new version of the buildpack is successful (as determined by one or more automated tests, such as an application smoke test) then the new version of the buildpack can be considered safe. In this case, each other application within the same cluster can be automatically flagged for update to the new version of the buildpack. The manifest files stored in the multi-tenant application file folder 202 can also be updated with the latest buildpack information by the multi-tenant application data hub controller 206, for example. If the latest version of the buildpack fails (e.g., based on a result of the application smoke test), then that version of the buildpack can be flagged as unsafe for upgrade.

In some embodiments, the user notification handler 212 can request approval from one or more users to proceed with restaging and/or deployment of the applications based on the flags. The user notification handler 212 can also send a notification to the user upon completion of restaging and/or deployment.

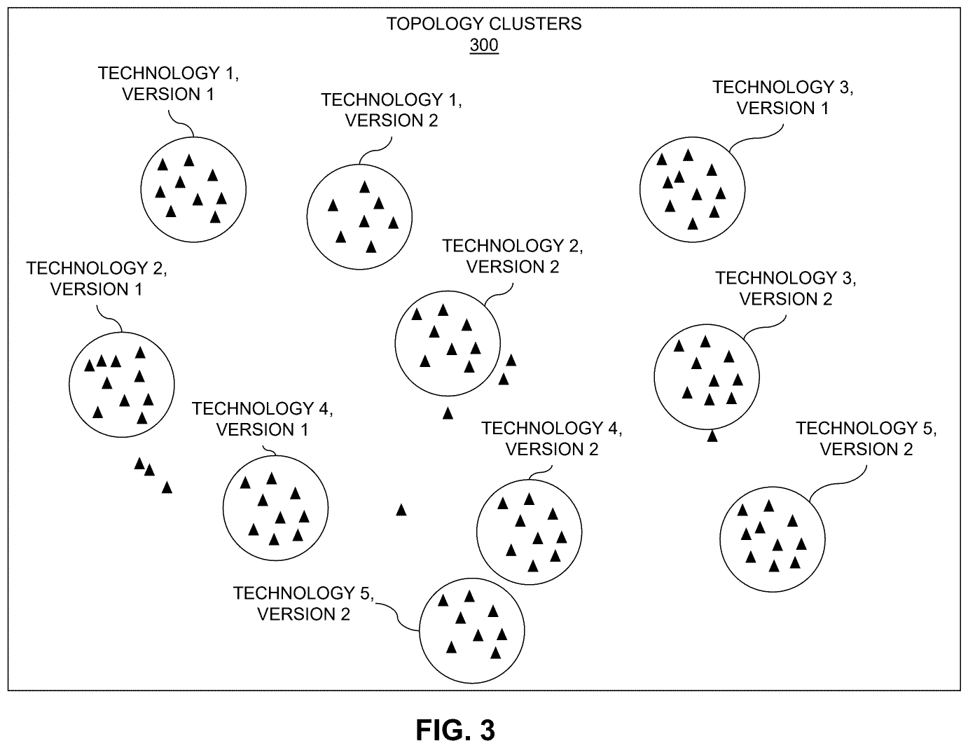

FIG. 3 shows an example of topology clusters 300 according to an illustrative embodiment, where each cluster is represented by a circle. The shaded triangles within a given cluster correspond to applications assigned to that cluster. In this example, each cluster corresponds to a particular technology and a particular version of that technology. For example, the topology clusters 300 include a first cluster for technology 1, version 1, and a second cluster for technology 1, version 2. Generally, the technology corresponds to software used by the applications, such as tools or libraries. As a non-limiting example, technology 1 can correspond to a type of database software tool, technology 2 can correspond to a logging library for particular types of applications (e.g., Java applications), technology 3 can correspond to a web application framework technology, technology 4 can correspond to tools and/or libraries associated with a first type of development kit, and technology 5 can correspond to another type of database technology. In some embodiments, each application can publish its application topology to a central repository (e.g., the multi-tenant application file folder 202), which is then used for clustering the application into different technologies and versions.

Consider an example where a new buildpack version is released (e.g., version 1.0.0.0). In such an example, some application owners (e.g. developers) may apply the buildpack sooner than others. In such an example, a first application can use the following: technology 1, version 2; technology 2, version 1; technology 3, version 2; and technology 5, version 2. If the buildpack is successfully applied and tested for a first application, then the results can be fed back to the system to update the topology clusters 300.

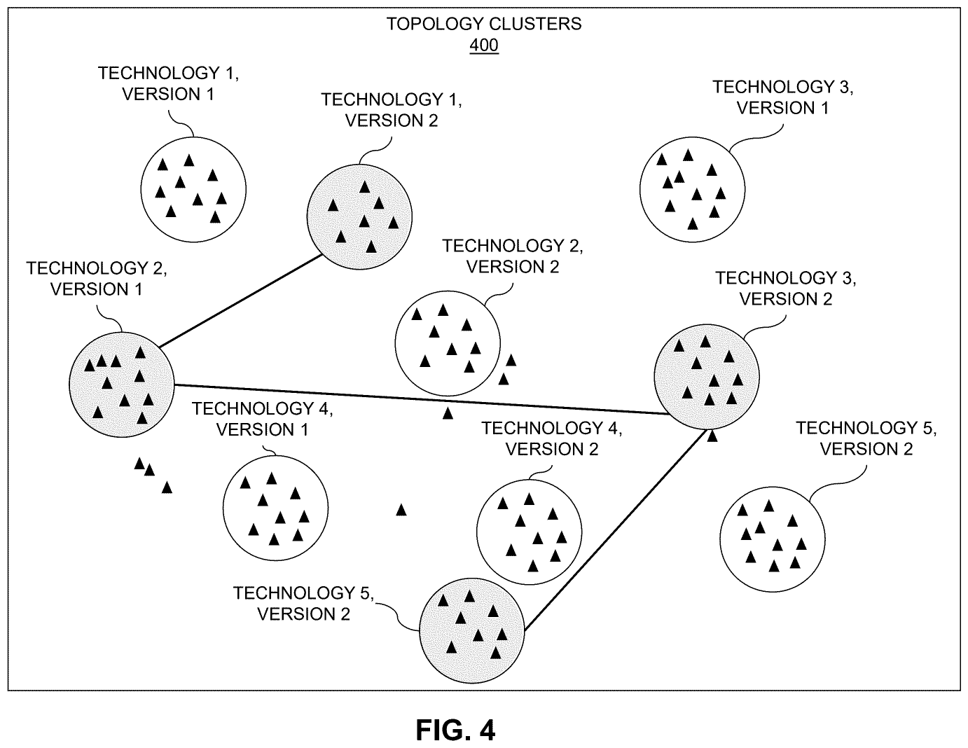

Referring also to FIG. 4, this figure shows an example of topology clusters 400 following the buildpack being successfully applied and tested. The clusters corresponding to the technologies used by the first application are flagged (as indicated by lightly shaded circles) to represent that the buildpack is safe for this particular application topology. In some embodiments, other applications having that topology can be flagged for upgrade using the new buildpack version.

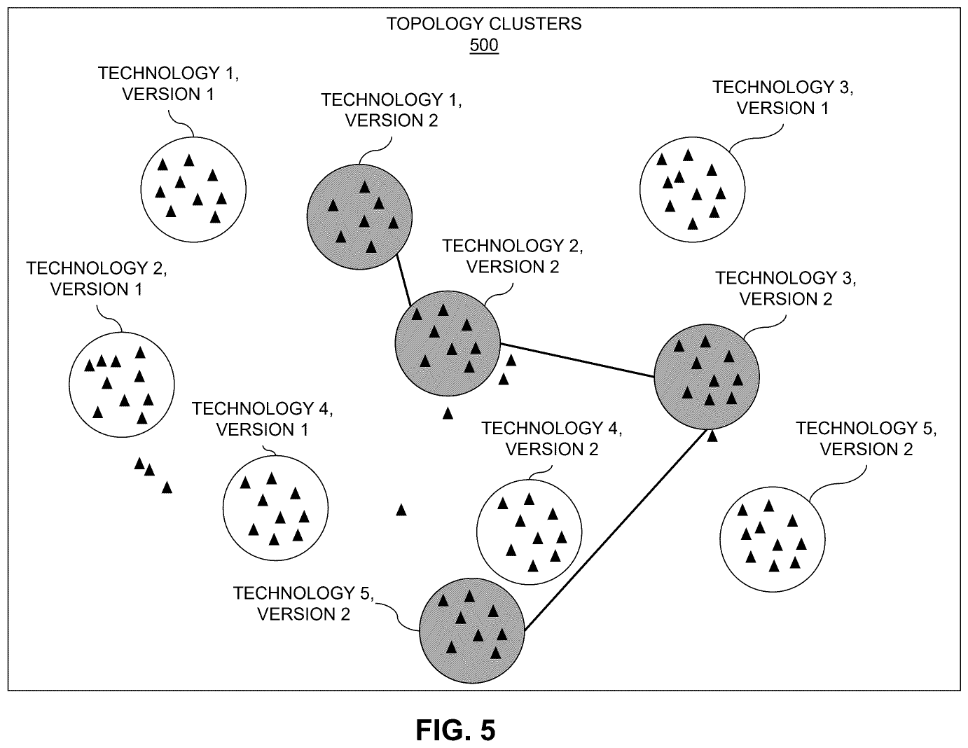

Referring also to FIG. 5, this figure shows an example of topology clusters 500 following the buildpack being unsuccessful for a second application. It is assumed that the second application uses the following technologies: technology 1, version 2; technology 2, version 2; technology 3, version 2; and technology 5, version 2. In FIG. 5, it is assumed that the second application applies the new buildpack version, and then performs a test to determine whether the deployment was successful (e.g., by attempting to access each service). In response to the test failing, the clusters corresponding to the technologies used by the second application are flagged (as indicated by darkly shaded circles) to represent that the buildpack was unsuccessful for the topology of the second application. In some embodiments, the manifest file for the second application can be replaced with the previous version in response to the buildpack being unsuccessfully applied.

In some embodiments, the flagged clusters shown in FIGS. 4 and 5 can be fed back to the content management module 116, which can trigger appropriate actions, such as notifying and/or updating one or more applications having topologies that are marked as safe, and notifying one or more users associated with an application having a topology that is marked as unsafe.

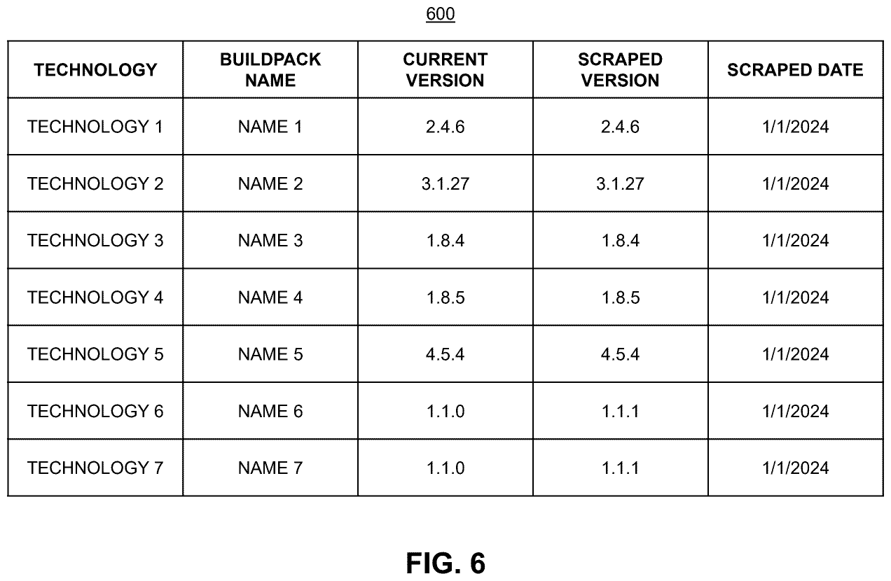

FIG. 6 illustrates an example of application build tool information 600 according to an illustrative embodiment. The application build tool information 600 can be maintained by the content management module 116, for example. The application build tool information 600 includes information for a plurality of technologies 1-7, including buildpack names, versions, scraped versions, and scraped dates. In some embodiments, the content management module 116 can update the data on a regular basis based on data collected from one or more online sources (e.g., using a suitable web scraping process). The most recent version of each technology can be retrieved and saved alongside the current buildpack. The application build tool information 600 can help detect changes by comparing the scraped version to the current version, for example. When there is a difference between the current version and the scraped version, the manifest file for the application can be updated. In some embodiments, the current version is updated to the scraped version when an application is not flagged as being unsafe.

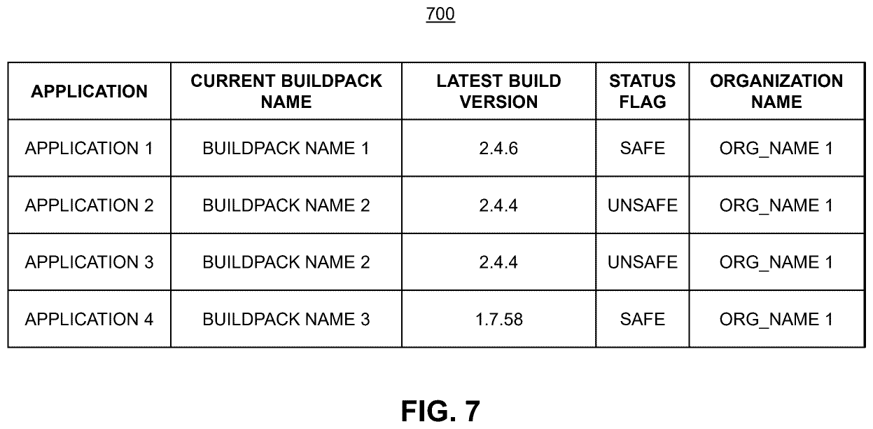

FIG. 7 illustrates an example of application management metadata 700 according to an illustrative embodiment. In this non-limiting example, the application management metadata 700 includes information for a plurality of applications (applications 1-4). In some embodiments, the application management metadata 700 is initially generated in response to an application management tool (e.g., application compliance monitoring tool 204) being installed. For example, the application management tool can request one or more paths for one or more local repositories of applications, as well as cloud organizations under which the applications are deployed. The application management metadata 700 can then track the applications under the various cloud organizations with their current buildpack names, latest build versions, and status flags. The status flags can correspond to whether the manifest file has been flagged as safe or unsafe, as explained above in conjunction with FIGS. 4-6, for example. The application management metadata 700 helps maintain the integrity of the applications across multiple users who attempt to update the applications for build compliance. The status flag monitors forthcoming and pending updates. The application can be updated to a newer version of the buildpack based on the status flags, for example.

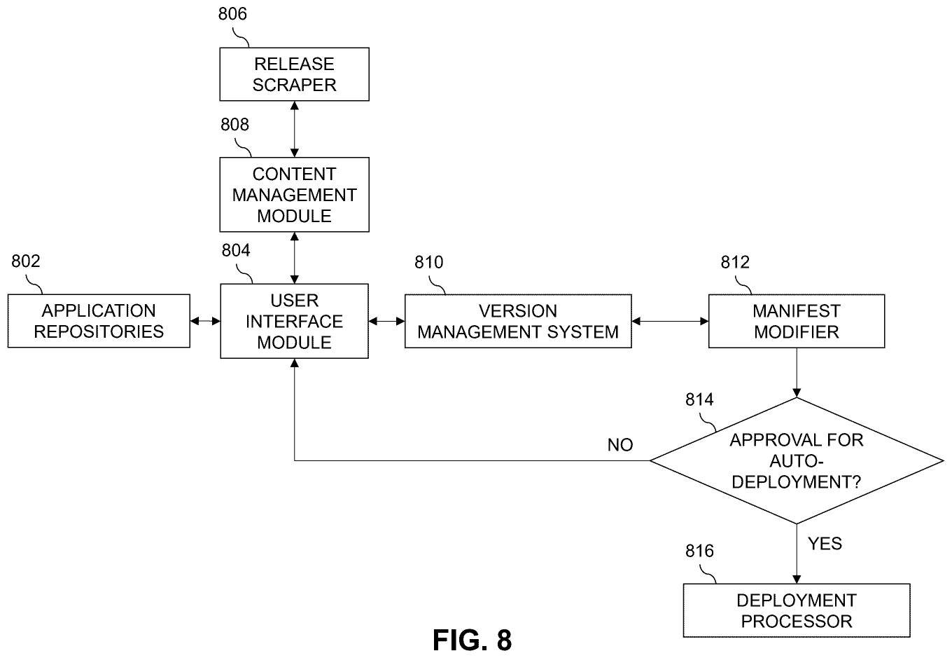

FIG. 8 illustrates a user interface and notification architecture according to an illustrative embodiment. In this example, the user interface module 804 collects information from one or more application repositories 802. The information can be used to generate and update metadata (e.g., application management metadata 700). The content management module 808 uses a release scraper 806 to obtain version information of buildpacks associated with the applications.

A version management system 810 is configured to check whether there are any mismatches between the versions of buildpacks obtained by the release scraper 806 and the buildpack versions in the metadata. In some embodiments, the version management system 810 also checks how many applications are using particular buildpacks.

The manifest modifier 812 identifies and updates manifest files with the latest buildpack information and can then send an alert to a user for approval to proceed with deployment. A test is performed to determine if the user has approved auto-deployment, as indicated by 814. If yes, a deployment processor automates the deployment and restaging of the application using the latest buildpack in 816. Otherwise, the user interface module 804 can send a notification that a new buildpack is available. If the application is successfully deployed, the user interface can send a notification that the deployment is successful, and the metadata can be updated accordingly along with build name and latest build for all relevant applications.

Some embodiments described herein provide a compliance maintenance framework that can be applied across multiple cloud organizations. In some embodiments a content management system can track recent buildpack versions for various technologies, along with dates corresponding to the buildpack versions.

The latest versions can be scraped from online sources using, for example, robotic process automation (RPA) technologies or a scheduled trigger, for instance. The latest versions are then compared to previously saved versions of the buildpack. If there are no changes, then the no action is needed. If a version mismatch is detected, then the repository information (application build tool information 600) is updated with the most recent version against all apps using the same build pack for the first user to deploy.

Following approval, a test is performed to check whether the restaging is successful. If so, then the buildpack version can be flagged as safe in the content management system, which can trigger the status flag in other applications to be updated. When a status change occurs in another application within a same cluster, then the manifest file for that application can be updated with the new buildpack name and version that was marked as safe.

In at least some embodiments, as changes are detected and resolved, notifications can be sent to request approval for beginning the deployment process for subsequent users. If approval is received, then the deployment and staging of the applications in the cloud can proceed. This includes performing one or more tests to check that the applications were successfully deployed and staged. The metadata can be updated based on the successful deployment of applications with the most recent build pack name, version, and status. The most recent buildpack name and version can be included in the manifest files for users who want to independently check and deploy applications.

The content management system can provide developers with a source for referencing compliant buildpack information across various technologies.

FIG. 9 is a flow diagram of a process for application program management using clustering and feedback in an illustrative embodiment. It is to be understood that this particular process is only an example, and additional or alternative processes can be carried out in other embodiments.

In this embodiment, the process includes steps 900 through 906. These steps are assumed to be performed at least in part by the application management system 105 utilizing its elements 112, 114, 116, 118, and 120.

Step 900 includes identifying at least one cluster of applications from among a plurality of applications based at least in part on structural information associated with the plurality of applications.

Step 902 includes determining that at least one application in the at least one cluster is using a first version of an application build tool.

Step 904 includes updating the application build tool to a second version of the application build tool for the at least one application in the at least one cluster.

Step 906 includes restaging the at least one application using the second version of the application build tool.

The updating may include updating metadata maintained for the at least one application to indicate that the application build tool successfully updated to the second version for the at least one application in the at least one cluster.

The process may further include updating the application build tool for at least one other application in the at least one cluster based at least in part on the updated metadata.

The restaging may include generating, using the updated application build tool, at least one container image of the at least one application based at least in part on an analysis of source code corresponding to the at least one application.

The process may include automatically deploying the at least one container image to one or more computing environments.

The process may include generating, in response to successful deployment of the at least one container image, at least one notification to be sent to at least one user associated with the at least one application.

The structural information may correspond to at least one of: one or more software components; one or more software dependencies; one or more application constraints; one or more application layers; one or more storage layers; and one or more interactions between the one or more software components.

The at least one cluster of applications may correspond to at least one of at least one of a software technology and a hardware technology utilized by the at least one application and a version of the at least one the software technology and the hardware technology.

At least a first portion of the plurality of applications may be associated with a first set of users, and at least a second portion of the plurality of applications may be associated with a second set of users.

Identifying the at least one cluster of applications may be based at least in part on the first set of users and the second set of users.

The second version may correspond to a current version of the application build tool, and the process may include periodically checking one or more online sources for the current version of the application build tool, and comparing the current version of the application build tool to the first version.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, technical problems associated with managing multiple applications, potentially maintained by different sets of users and/or organizations, are mitigated in one or more embodiments by automatically updating versions of application build tools for one or more clusters of applications to ensure that the applications maintain compliance with application build tool standards. These and other embodiments can effectively overcome problems associated with existing testing techniques that rely on manually updating application build tools, which can lead to issues such as missed updates, security vulnerabilities, and/or compliance issues.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

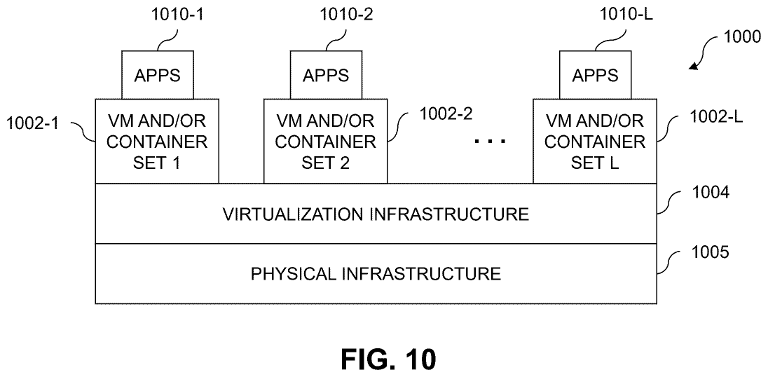

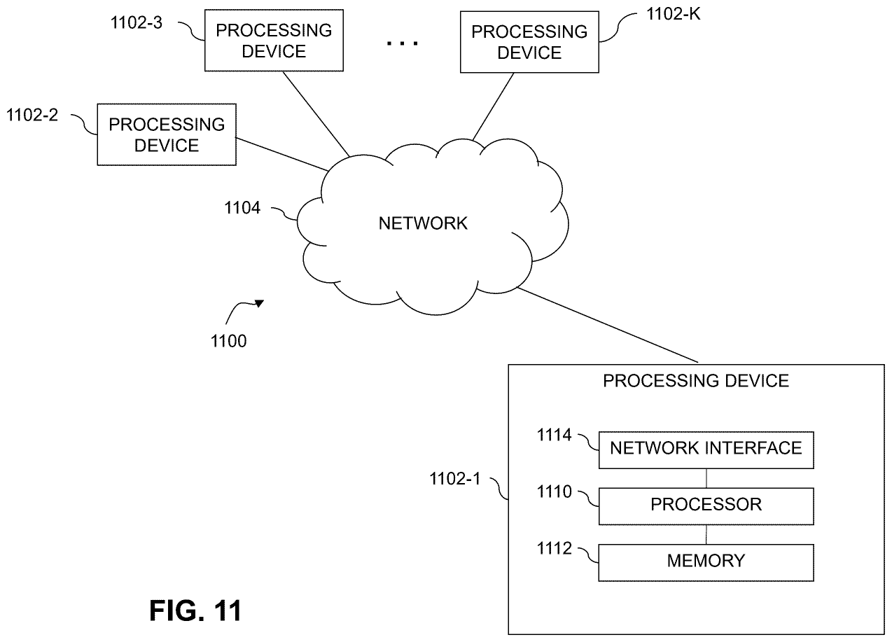

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, a microcontroller, an ASIC, an FPGA or other type of processing circuitry, as well as portions or combinations of such circuitry elements.

The memory 1112 comprises RAM, ROM or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying at least one cluster of applications from among a plurality of applications based at least in part on structural information associated with the plurality of applications;
determining that at least one application in the at least one cluster is using a first version of an application build tool;
updating the application build tool to a second version of the application build tool for the at least one application in the at least one cluster; and
restaging the at least one application using the second version of the application build tool;
wherein the method is performed by at least one processing device comprising a processor coupled to a memory.

2. The computer-implemented method of claim 1, wherein the updating comprises:
updating metadata maintained for the at least one application to indicate that the application build tool successfully updated to the second version for the at least one application in the at least one cluster.

3. The computer-implemented method of claim 2, further comprising:
updating the application build tool for at least one other application in the at least one cluster based at least in part on the updated metadata.

4. The computer-implemented method of claim 1, wherein the restaging comprises:
generating, using the updated application build tool, at least one container image of the at least one application based at least in part on an analysis of source code corresponding to the at least one application.

5. The computer-implemented method of claim 4, further comprising:
automatically deploying the at least one container image to one or more computing environments.

6. The computer-implemented method of claim 5, further comprising:
generating, in response to successful deployment of the at least one container image, at least one notification to be sent to at least one user associated with the at least one application.

7. The computer-implemented method of claim 1, wherein the structural information corresponds to at least one of:
one or more software components;
one or more software dependencies;
one or more application constraints;
one or more application layers;
one or more storage layers; and
one or more interactions between the one or more software components.

8. The computer-implemented method of claim 1, wherein the at least one cluster of applications corresponds to at least one of:
at least one of a software technology and a hardware technology utilized by the at least one application; and
a version of the at least one the software technology and the hardware technology.

9. The computer-implemented method of claim 1, wherein:
at least a first portion of the plurality of applications is associated with a first set of users; and
at least a second portion of the plurality of applications is associated with a second set of users.

10. The computer-implemented method of claim 9, wherein the identifying is based at least in part on the first set of users and the second set of users.

11. The computer-implemented method of claim 1, wherein the second version corresponds to a current version of the application build tool, and wherein the method further comprises:
periodically checking one or more online sources for the current version of the application build tool; and
comparing the current version of the application build tool to the first version.

12. A non-transitory processor-readable storage medium having stored therein program code of one or more software programs, wherein the program code when executed by at least one processing device causes the at least one processing device:
to identify at least one cluster of applications from among a plurality of applications based at least in part on structural information associated with the plurality of applications;
to determine that at least one application in the at least one cluster is using a first version of an application build tool;
to update the application build tool to a second version of the application build tool for the at least one application in the at least one cluster; and
to restage the at least one application using the second version of the application build tool.

13. The non-transitory processor-readable storage medium of claim 12, wherein the updating comprises:
updating metadata maintained for the at least one application to indicate that the application build tool successfully updated to the second version for the at least one application in the at least one cluster.

14. The non-transitory processor-readable storage medium of claim 13, wherein the program code, when executed by the at least one processing device, further causes the at least one processing device:
to update the application build tool for at least one other application in the at least one cluster based at least in part on the updated metadata.

15. The non-transitory processor-readable storage medium of claim 12, wherein the restaging comprises generating, using the updated application build tool, at least one container image of the at least one application based at least in part on an analysis of source code corresponding to the at least one application, and wherein the program code, when executed by the at least one processing device, further causes the at least one processing device:
to automatically deploy the at least one container image to one or more computing environments.

16. The non-transitory processor-readable storage medium of claim 15, wherein the program code, when executed by the at least one processing device, further causes the at least one processing device:
to generate, in response to successful deployment of the at least one container image, at least one notification to be sent to at least one user associated with the at least one application.

17. An apparatus comprising:
at least one processing device comprising a processor coupled to a memory;
the at least one processing device being configured:
to identify at least one cluster of applications from among a plurality of applications based at least in part on structural information associated with the plurality of applications;
to determine that at least one application in the at least one cluster is using a first version of an application build tool;
to update the application build tool to a second version of the application build tool for the at least one application in the at least one cluster; and
to restage the at least one application using the second version of the application build tool.

18. The apparatus of claim 17, wherein the updating further comprises:
updating metadata maintained for the at least one application to indicate that the application build tool successfully updated to the second version for the at least one application in the at least one cluster.

19. The apparatus of claim 18, wherein the at least one processing device is further configured:
to update the application build tool for at least one other application in the at least one cluster based at least in part on the updated metadata.

20. The apparatus of claim 18, wherein the restaging comprises generating, using the updated application build tool, at least one container image of the at least one application based at least in part on an analysis of source code corresponding to the at least one application, and wherein the at least one processing device is further configured:
to automatically deploy the at least one container image to one or more computing environments.
